(19) United States
(12) Patent Application Publication
(10) Pub. No.: US 2011/0114712 A1
(43) Pub. Date: May 19, 2011

(54) CORRUGATED CONTAINER HAVING A NON-CONTINUOUS LAYER

(75) Inventors: Charles Malo, Boucherville (CA); Maurice Plante, Cabano (CA)

(73) Assignee: CASCADES CANADA INC., Saint-Bruno (CA)

(21) Appl. No.: 12/617,815

(22) Filed: Nov. 13, 2009

(51) Int. Cl. B65D 5/00; B31B 17/00; B32B 3/28

(52) U.S. Cl. 229/100; 493/84; 428/182

(57) ABSTRACT

A corrugated fiberboard container and a method and apparatus for constructing a corrugated fiberboard section. A corrugated fiberboard is disclosed that includes: a first layer formed from a first continuous section of material; a second layer formed from a plurality of non-continuous sections of material, wherein at least two of the non-continuous sections comprise different materials.

### FIELD OF THE INVENTION

This disclosure is related to a corrugated container and its construction, and more particularly to a corrugated container having a non-continuous layer made from different materials.

### BACKGROUND OF THE INVENTION

Corrugated fiberboard, also known as corrugated cardboard, is a paper-based construction material consisting of a fluted corrugated sheet and one or two flat linerboards (“liner”). It is widely used in the manufacture of corrugated boxes, bins and shipping containers.

FIG. 1 depicts an example of a sheet of corrugated fiberboard 10, which is formed as a series of layered materials, including a first liner 12, a second liner 14 and a fluted medium 16. The corrugated medium 16 and liners 12 and 14 are made of paperboard, a paper-like material usually over nine mils thick. (Paperboard and corrugated fiberboard are sometimes referred to as cardboard, although cardboard might be any heavy paper-pulp based board.)

FIG. 2 depicts a box blank 18 for a regular slotted container cut from a sheet of corrugated fiberboard. As can be seen, box blank 18 includes cut-outs 20 and creases 22 to form a box body 24 and flaps 26. FIG. 3 depicts a resulting corrugated fiberboard box 28 formed from the box blank 18 of FIG. 2.

One of the challenges with constructing corrugated fiberboard is to find ways to reduce the cost of materials utilized to produce a container without sacrificing performance. For instance, rolls of material are typically cut to meet the size requirements of a particular application, leaving leftover material that has little value except as recycling material.

### SUMMARY OF THE INVENTION

The present invention relates to a corrugated fiberboard container and a method and apparatus for constructing corrugated fiberboard in which at least one of the layers (e.g., the corrugated medium or one or more liners) are formed in a non-continuous manner from different materials. In one embodiment, there is a corrugated fiberboard section, comprising: a first layer formed from a first continuous section; and a second layer formed adjacent the first layer from a plurality of non-continuous sections, wherein at least two of the non-continuous sections are formed from different materials.

In a second embodiment, there is container having a body; and a plurality of flaps; wherein the body and plurality of flaps are formed from: a first layer formed from a first continuous section; and a second layer formed adjacent the first layer from a plurality of non-continuous sections, wherein at least two of the non-continuous sections are formed from different materials.

In a third embodiment, there is an apparatus for constructing a corrugated fiberboard, comprising: a mechanism for holding a first roll of a paper material of a first type having a first width; a mechanism for holding a second roll of the paper material of a second type having a second width; a system for feeding the paper material from the first roll and the second roll next to each other to form a layer having non-continuous sections; and a system for gluing the layer having non-continuous sections to an adjacent layer.

In a fourth embodiment, there is a method for forming a corrugated fiberboard, comprising: providing a first roll of a paper material of a first type having a first width; providing a second roll of the paper material of a second type having a second width; feeding the paper material from the first roll and the second roll next to each other to form a layer having non-continuous sections; and gluing the layer having non-continuous sections to an adjacent layer.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a corrugated fiberboard.

FIG. 2 depicts a box blank.

FIG. 3 depicts a box formed from the box blank of FIG. 2.

FIG. 4 depicts a non-continuous layer of a corrugated fiberboard in accordance with an embodiment of the present invention.

FIG. 5 depicts an end view of the non-continuous layer of FIG. 4 along A-A in accordance with an embodiment of the present invention.

FIG. 6 depicts an isometric view of a non-continuous layer in accordance with an embodiment of the present invention.

FIG. 7 depicts a method for forming a non-continuous layer in accordance with an embodiment of the present invention.

FIG. 8 depicts an apparatus for forming corrugated fiberboard using an in-line process for providing a non-continuous layer and resulting box blanks in accordance with an embodiment of the present invention.

FIG. 9 depicts a box blank in accordance with an embodiment of the present invention.

FIG. 10 depicts a resulting box from the box blank of FIG. 9 in accordance with an embodiment of the present invention.

The drawings are merely schematic representations, not necessarily drawn to scale and not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention provides an improved corrugated container and method of manufacture that more efficiently utilizes paper and thus saves natural resources and costs. For the purposes of this disclosure, the term “corrugated fiberboard” refers to any paper based board that includes at least one fluted corrugated sheet (a medium) and at least one liner. In addition, the term “container” refers to any container, box, bin, etc., constructed from corrugated fiberboard.

A corrugated fiberboard container and its method of manufacture are described in which at least one of the layers is formed in a non-continuous manner from different types of material. A non-continuous layer may be defined as a layer (e.g., a medium or a liner) of the corrugated fiberboard that is formed using more than one separate sections of material. The separate sections are formed from different types, e.g., quality, of material and are held in place with an adhesive to one or more adjacent layers.

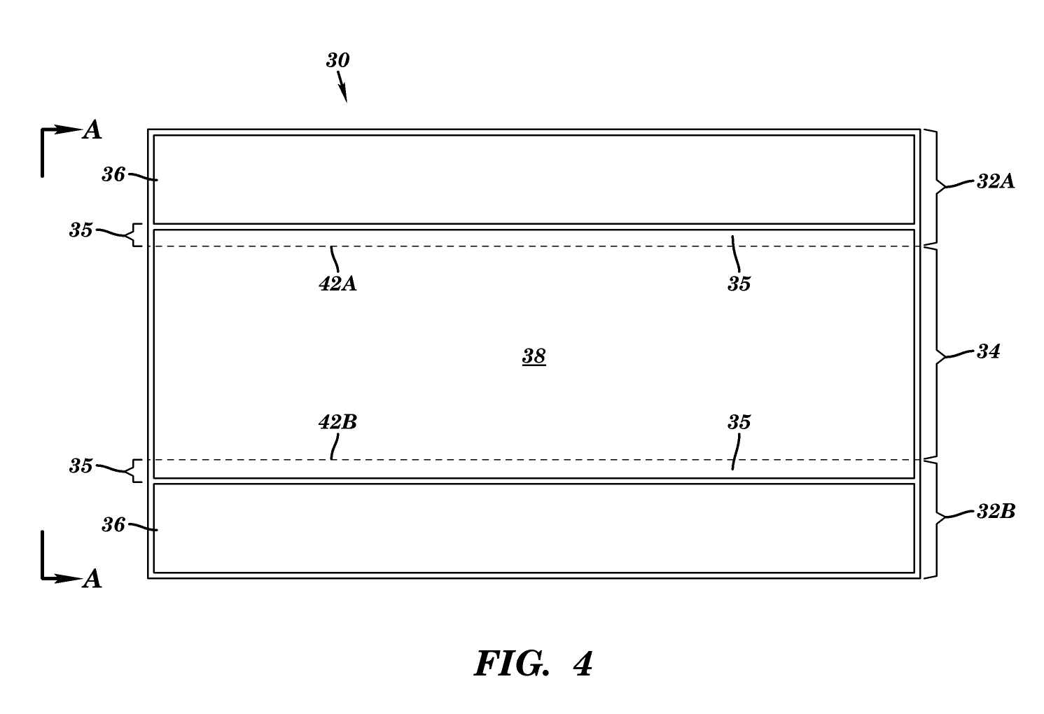

FIG. 4 depicts a top view of an illustrative embodiment of a fiberboard section 30 having a non-continuous corrugated medium layer. In this embodiment, a non-continuous corrugated medium is essentially formed from three separate sections, including a central section 38 formed from a first piece of corrugated medium of a first type, and edge sections 36 formed from second and third pieces of corrugated medium of a second type. In this example, adjacent sections are separated slightly from each other. However, this is not a requirement, and adjacent sections may be touching, overlapping, glued together, etc. Sections 36 and 38 are held in place relative to one another as a result of adhesive that is applied to one or more adjacent layers, as is typically done in forming a corrugated fiberboard from continuous layers. (Note that a top adjacent layer is not shown in order to better describe the structure, however, adjacent layers of either a liner or additional corrugated medium may be utilized on both sides.)

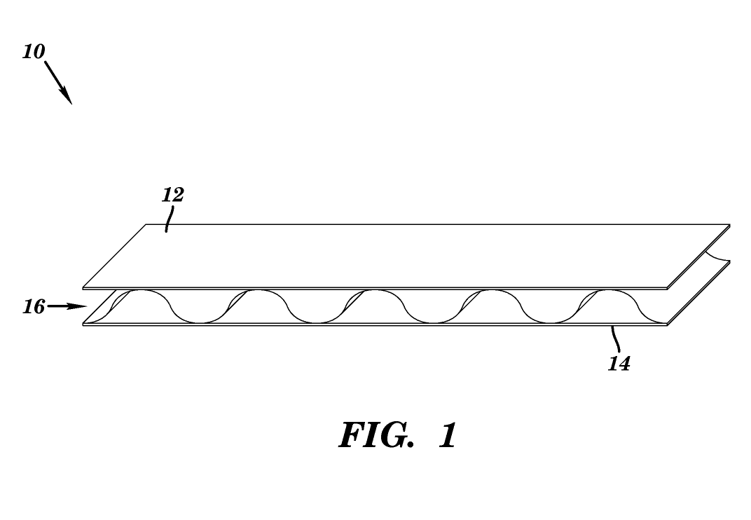

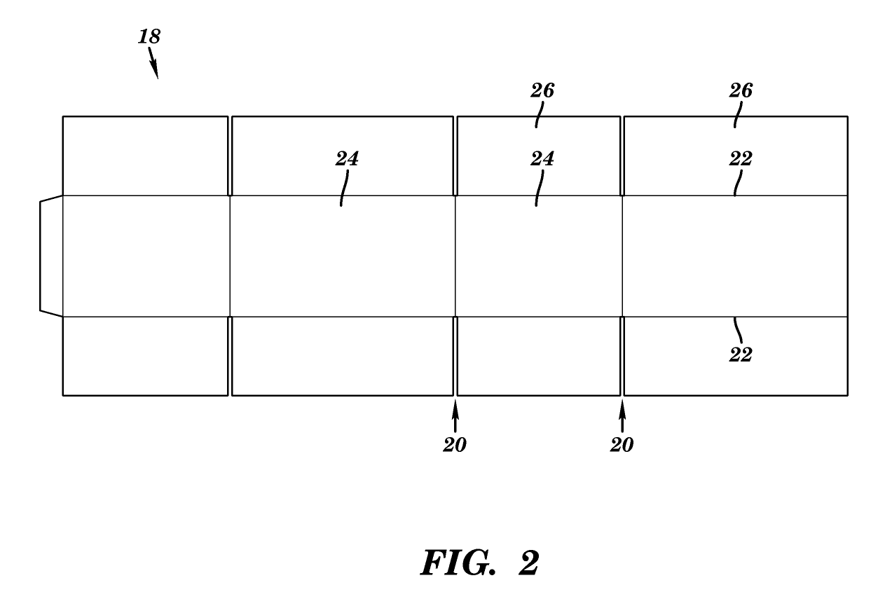

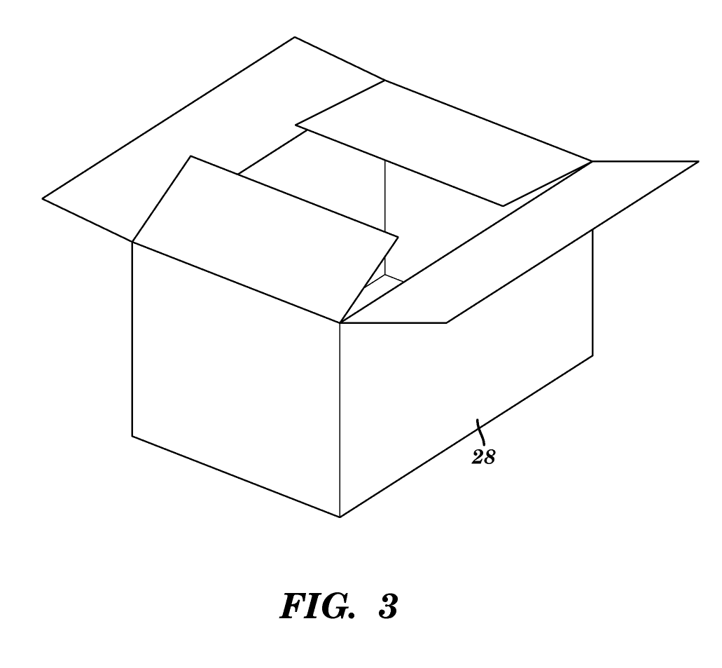

This illustrative fiberboard section 30 will ultimately form a container (such as that described in FIGS. 1-3) that includes a body region 34 and flap regions 32A and 32B. The body region 34 and flap regions 32A and 32B are separated by creases or fold lines 42A and 42B. In this particular embodiment, the central section 38 of corrugated medium covers the entire body region 34 and overlaps slightly onto each flap region 32A and 32B. Accordingly, overlap regions 35 are formed where the central section 38 of the medium overlaps the flap regions 32A and 32B. The amount of each overlap region 35 can vary, e.g., an inch or so, depending on the application. It is understood that overlap regions 35 are not necessary, i.e., the central section 38 of medium could end at (or before) the fold lines 42A, 42B. However, by extending the central section 38 of medium onto the flap regions 32A, 32B, integrity of the configuration is improved.

As noted, the central section 38 of corrugated medium is formed from a first type of material and edge sections 36 are formed from a second type of material. For instance, central section 38 may be formed from a corrugated medium having a first weight, e.g., 40 pound per thousand square foot paper, while edge sections 36 may be form from a corrugated medium having a second weight, e.g., 26 pound per thousand square foot paper. This allows less costly material to be used, e.g., on the flaps, where strength is not as important.

In another embodiment, central section 38 and edge sections 36 may be formed from different liner materials (as opposed to a corrugated medium). Moreover, central section 38 could be formed from a corrugated medium and one or both edge sections 36 could be formed from a liner. Accordingly, the invention includes any formation in which non-continuous sections are formed from different materials (e.g., liner type 1 and liner type 2; liner and corrugated medium; corrugated medium type 1 and corrugated medium type 2; etc.).

It is understood that any variations with respect to the location, number, dimensions, material, and positioning of adjacent sections forming a non-continuous layer are included within the scope of the invention. In addition, in the case where a multilayer liner is utilized, one or more of the liner layers may likewise be formed in a non-continuous manner as describe herein. In other words, any layer, including one or more of the liner layers or corrugated medium may be formed from separate non-continuous sections of material.

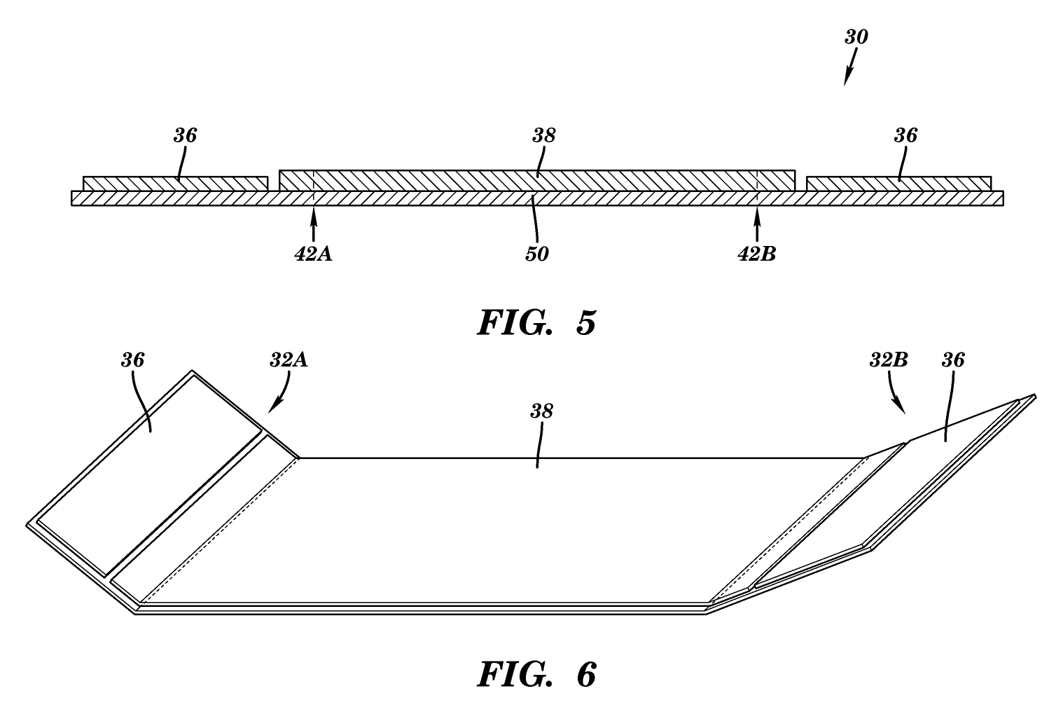

FIG. 5 depicts an end view of the fiberboard section 30 along perspective A-A of FIG. 4. In this figure, a liner 50 is shown (on the bottom side) with the central section of medium 38 and edge sections 36 adhered thereto, thus forming three non-continuous medium sections 36, 38 on a continuous liner 50. In an illustrative embodiment, a second top layer (not shown) may be adhered to the top of the three non-continuous medium sections 36, 38. As can be seen, the central section 38 is formed from a thicker, stronger material than the edge sections 36.

It is understood that numerous variations of a fiberboard having non-continuous sections are included within the scope of this invention and that the number, size, arrangement and type of non-continuous sections among the layers are not limited. Moreover, the thicknesses and characteristics of the fiberboard 30 including the medium sections 36, 38 and liner 50 are not limited to a particular type, size, or value. For instance, multiple layered corrugated medium (i.e., double and triple wall board) may utilize layers having the same or different discontinuities; multiple layered liners may comprise one or more layers having non-continuous sections; a larger main section may be coupled with a single edge section; a main section may be coupled with secondary sections of different dimensions; etc.

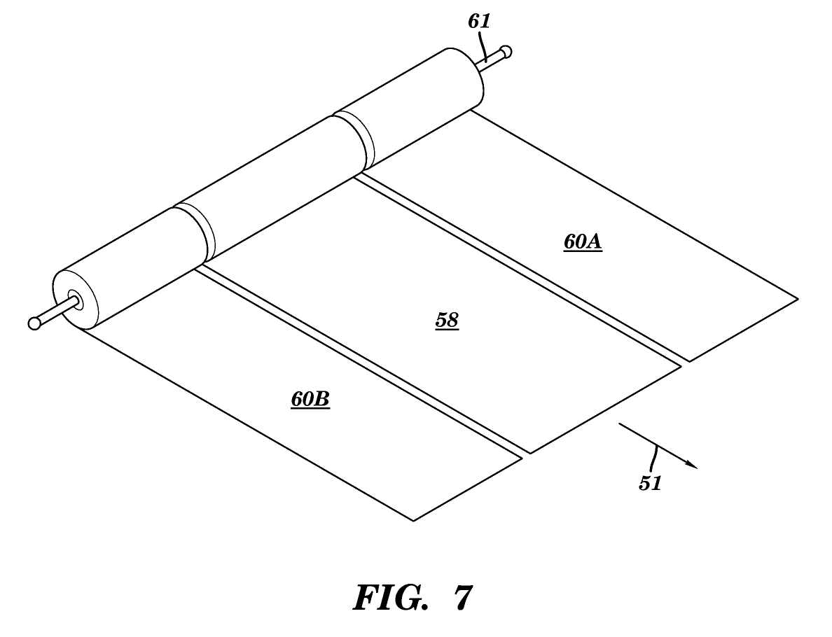

FIG. 6 depicts an isometric view of the fiberboard 30 with flaps 32A and 32B folded along the crease lines. Note that while the above embodiments describe a fiberboard application in which the non-continuous sections reside on the flaps, the invention is not limited to such specific embodiments. Rather, the invention applies to any fiberboard application in which one or more non-continuous layers are utilized for more efficient use of paper while maintaining a required amount of structural integrity. For example, an alternative embodiment may comprise a box configuration in which one out of four walls includes a stronger non-continuous section of material than the other three walls.

FIG. 7 depicts a multi-feed roller for forming a non-continuous layer using three different rolls 58, 60A and 60B of material. In this case, roll 60A may comprise a first material, roll 60B a second material and roll 58 a third material. To form a layer, the three rolls of material are simultaneously fed along arrow 51, e.g., within a corrugator apparatus. In this embodiment, the three rolls are positioned along a common roller shaft 61; however such a configuration is not required. Rather one or more of the rolls could be offset using multiple roller shafts or mill roll stands (not shown). In the example shown, the roller shaft 61 could be expandable to accommodate different sized rolls of material.

In the example shown in FIG. 7, it can be seen that edge sections 60A and 60B are of a generally smaller width than central section 58. Efficient use of paper is achieved because in a paper mill, it is not unusual to have to cut a roll of material to a specific width for a given application. For instance, a 220″ wide paper machine may run two 98″ rolls across the web, thus creating a 24″ trim roll. This trim roll is too narrow to run conventionally on a corrugator and is thus sold at a steep discount.

However, the present invention allows leftover trim rolls to be used for a section of a given layer, even if it is not the same type of material as adjacent sections. For instance, roll 60A and/or 60B may have been leftover trim rolls that can be used in this application as edge sections. As such, the dimensions of the different non-continuous sections ultimately may be dictated by the particular material on hand. Regardless, the ability to re-use trim rolls in this manner represents a significant cost savings.

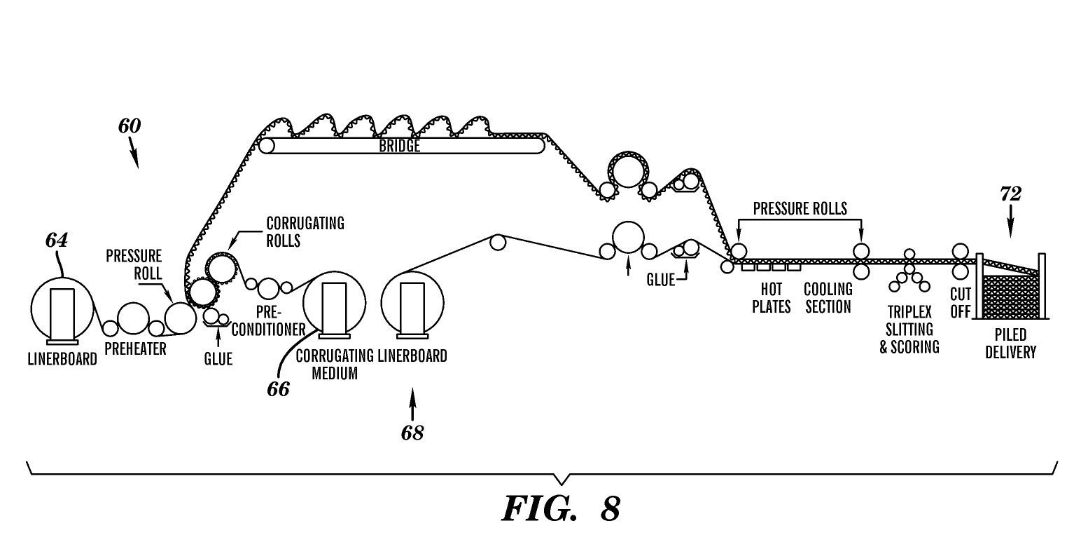

FIG. 8 depicts a simplified schematic of a corrugator apparatus 60 for incorporating non-continuous layers into corrugated fiberboard sections (i.e., box blanks) 72. Corrugator apparatus 60 includes a corrugated medium source 66 (e.g., a mechanism holding a roll of corrugating medium) a linerboard source 64 (e.g., a mechanism holding a roll of linerboard) for forming a single layer liner on a first side, and a liner board sources 68 for forming a single layer liner on a second side. In one embodiment, corrugated medium source 66 would comprise a multi-feed roller, such as that described in FIG. 7 to provide a non-continuous medium layer. Note that the apparatus shown in FIG. 8 is depicted for illustrative purposes only, and variations are possible.

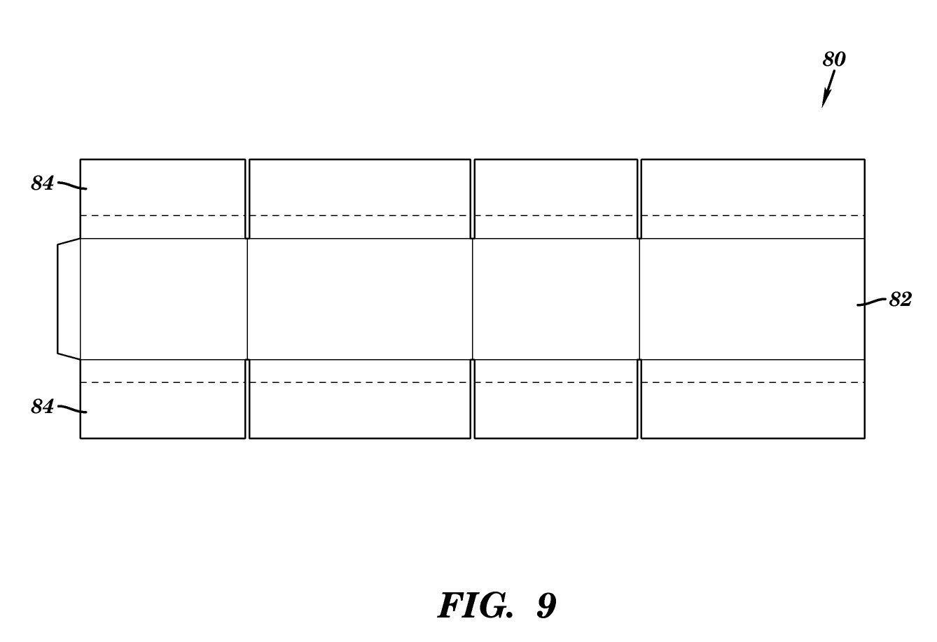

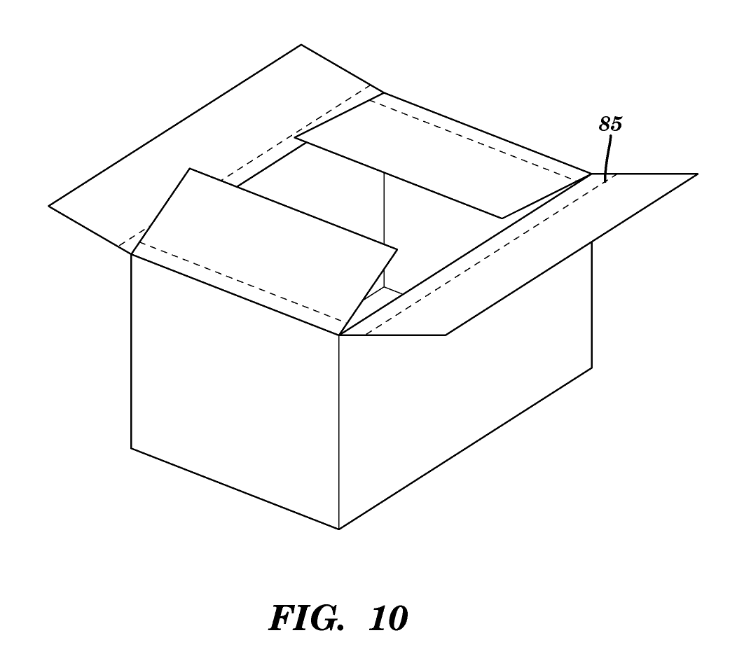

FIG. 9 depicts a resulting box blank 80 that has a non-continuous corrugated medium layer (shown in phantom) that includes a central section 82 (comprised of a first material) between the dash lines, and edge sections 84 (comprised of a second material) outside the dashed lines. FIG. 10 depicts the resulting container. As can be seen, because the discontinuity 85 occurs within the flaps, structural integrity of the overall container is maintained.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A corrugated fiberboard section, comprising:
a first layer formed from a first continuous section; and
a second layer formed adjacent the first layer from a plurality of non-continuous sections, wherein at least two of the non-continuous sections are formed from different materials.

2. The corrugated fiberboard section of claim 1, wherein each of the non-continuous sections comprise a corrugated medium.

3. The corrugated fiberboard section of claim 1, wherein each of the non-continuous sections comprise a liner.

4. The corrugated fiberboard section of claim 1, wherein the plurality of non-continuous sections includes a main section and at least one edge section, wherein the edge section resides within a flap region of a resulting container.

5. The corrugated fiberboard section of claim 4, wherein the main section extends into a portion of the flap region.

6. The corrugated fiberboard section of claim 1, wherein adjacent non-continuous sections are separated by a space.

7. The corrugated fiberboard section of claim 1, wherein adjacent non-continuous sections touch each other.

8. The corrugated fiberboard section of claim 1, wherein adjacent non-continuous sections overlap each other.

9. The corrugated fiberboard section of claim 1, wherein the second layer is glued to the first layer.

10. A corrugated fiberboard container, comprising:
a body; and
a plurality of flaps;
wherein the body and plurality of flaps are formed from:
a first layer formed from a first continuous section; and
a second layer formed adjacent the first layer from a plurality of non-continuous sections, wherein at least two of the non-continuous sections are formed from different materials.

11. The corrugated fiberboard container of claim 10, wherein each of the at least two non-continuous sections comprises a corrugated medium.

12. The corrugated fiberboard container of claim 10, wherein each of the at least two non-continuous sections comprises a liner.

13. The corrugated fiberboard container of claim 10, wherein the plurality of non-continuous sections of material includes a main section and at least one edge section, wherein the edge section resides within one of the flaps of the container.

14. The corrugated fiberboard container of claim 13, wherein the main section extends into a portion of the flap.

15. The corrugated fiberboard container of claim 10, wherein adjacent non-continuous sections of material are separated by a space.

16. The corrugated fiberboard container of claim 10, wherein adjacent non-continuous sections of material touch each other.

17. The corrugated fiberboard container of claim 10, wherein adjacent non-continuous sections of material overlap each other.

18. The corrugated fiberboard container of claim 10, wherein the interior layer is glued to the first layer.

19. An apparatus for constructing a corrugated fiberboard, comprising:
a mechanism for holding a first roll of a paper material of a first type having a first width;
a mechanism for holding a second roll of the paper material of a second type having a second width;
a system for feeding the paper material from the first roll and the second roll next to each other to form a layer having non-continuous sections; and
a system for gluing the layer having non-continuous sections to an adjacent layer.

20. The apparatus of claim 19, wherein the layer comprises a corrugated medium.

21. The apparatus of claim 19, wherein the layer comprises a liner.

22. The apparatus of claim 19, wherein the non-continuous sections include a main section and at least one edge section, wherein the edge section resides within a flap region of a resulting container.

23. The apparatus of claim 19, wherein the main section extends into a portion of the flap region.

24. The apparatus of claim 19, wherein the non-continuous sections are separated by a space.

25. The apparatus of claim 19, wherein the non-continuous sections touch each other.

26. The apparatus of claim 19, wherein the non-continuous sections overlap each other.

27. A method for forming a corrugated fiberboard, comprising:
providing a first roll of a paper material of a first type having a first width;
providing a second roll of the paper material of a second type having a second width;
feeding the paper material from the first roll and the second roll next to each other to form a layer having non-continuous sections; and
gluing the layer having non-continuous sections to an adjacent layer.

28. The method of claim 27, wherein the layer comprises a corrugated medium.

29. The method of claim 27, wherein the layer comprises a liner.

30. The method of claim 27, wherein the non-continuous sections include a main section and at least one edge section, wherein the edge section resides within a flap region of a resulting container.

31. The method of claim 27, wherein the main section extends into a portion of the flap region.

32. The method of claim 27, wherein the non-continuous sections are separated by a space.

33. The method of claim 27, wherein the non-continuous sections touch each other.

34. The method of claim 27, wherein the non-continuous sections overlap each other.
